(19) United States
(12) Patent Application Publication
(10) Pub. No.: US 2014/0279312 A1
(43) Pub. Date: Sep. 18, 2014

(54) SYSTEM AND METHOD FOR PROVIDING AUTOMATED CHARGEBACK OPERATIONS

(71) Applicant: Capital One Financial Corporation, McLean, VA (US)

(72) Inventors: Harlon K. MASON, Montpelier, VA (US); Abhishek ASTHANA, Glen Allen, VA (US); Brenda D. MILLS, Prince George, VA (US); John E. MARTIN, Arlington, VA (US)

(73) Assignee: Capital One Financial Corporation, McLean, VA (US)

(21) Appl. No.: 14/211,202

(22) Filed: Mar. 14, 2014

Related U.S. Application Data
(60) Provisional application No. 61/788,763, filed on Mar. 15, 2013.

(51) Int. Cl. G06Q 40/00

(52) U.S. Cl. CPC G06Q 40/12
USPC 705/30

(57) ABSTRACT

Embodiments of the present disclosure provide systems and methods for automated chargeback processing, including hardware and software for storing, in a database, transaction data associated with one or more transactions in a queue, retrieving transaction data associated with one or more transactions stored in the queue, for each transaction in the queue, applying, using an automated chargeback processor, one or more rules to the transaction data, identifying, using the automated chargeback processor, the transaction data as eligible or ineligible for chargeback processing based on the one or more rules, determining, using the automated chargeback processor, whether additional documentation is required, and sending, via a network, instructions to perform a chargeback operation for an account associated with the transaction data.

### CROSS-REFERENCE TO RELATED APPLICATIONS

This application claims priority to U.S. Provisional Patent Application No. 61/788,763, filed on Mar. 15, 3013, the entire contents of which is incorporated by reference.

### FIELD OF THE DISCLOSURE

The present disclosure relates to systems and methods for providing automated chargebacks of transactions on fraudulent accounts.

### BACKGROUND OF THE DISCLOSURE

Conventional chargeback processes require agents that manually investigate all transactions. This can lead to inconsistent chargeback processing, delay in a response causing loss of chargeback rights after a chargeback timeline has expired, and representments and/or arbitration due to incorrect chargebacks.

These and other drawbacks exist.

### SUMMARY OF THE DISCLOSURE

Embodiments of the present disclosure provide systems and methods for automated chargeback processing, including hardware and software for storing, in a database, transaction data associated with one or more transactions in a queue, retrieving transaction data associated with one or more transactions stored in the queue, for each transaction in the queue, applying, using an automated chargeback processor, one or more rules to the transaction data, identifying, using the automated chargeback processor, the transaction data as eligible or ineligible for chargeback processing based on the one or more rules, determining, using the automated chargeback processor, whether additional documentation is required, and sending, via a network, instructions to perform a chargeback operation for an account associated with the transaction data.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts an example embodiment of a system implementing automated chargeback operations;

FIG. 2 an example embodiment of a system implementing automated chargeback operations;

FIG. 3 depicts an example embodiment of a method of performing an automated chargeback operation; and

FIG. 4 depicts an example embodiment of a method of performing an automated chargeback operation.

### DETAILED DESCRIPTION OF THE EMBODIMENTS

The following description is intended to convey a thorough understanding of the embodiments described by providing a number of specific example embodiments and details involving systems and methods for implementing automated chargeback operations. It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in various embodiments, depending on specific design and other needs. A financial institution and system supporting a financial institution are used as examples for the disclosure. The disclosure is not intended to be limited to financial institutions only.

According to the various embodiments of the present disclosure, systems and methods enable automated chargebacks for transactions performed using one or more accounts. The term chargeback as referred to herein may refer to the return of funds to a consumer or account holder, forcibly initiated by the issuing bank of the instrument used by a consumer to settle a debt. Specifically, a chargeback may be the reversal of a prior outbound transfer of funds from an account holder's one or more financial accounts. Automated chargeback operations may be utilized to reduce the time it takes to initiate a chargeback process, eliminate errors associated with manual chargebacks, and minimize the involvement of one or more fraud agents. The chargeback process may be automated using various systems and methods as described herein.

FIG. 1 depicts an example embodiment of a system 100 for implementing automated chargeback operations. The system may include various network-enabled computer systems, including, as depicted in FIG. 1 for example, a financial institution 101; an automated chargeback system 102 comprising a Rules Processor 103, a chargeback processor 104, and a case database 105. In the example embodiment shown in FIG. 1, automated chargeback system 102 is disclosed as a separate component from financial institution 101. System 102 also may be integrated into, for example, financial institution 101. As referred to herein, a network-enabled computer system and/or device may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The network-enabled computer systems may execute one or more software applications to, for example, receive data as input from an entity accessing the network-enabled computer system, process received data, transmit data over a network, and receive data over a network. The one or more network-enabled computer systems may also include one or more software applications to perform automated chargeback operations, as described herein. It is also noted that the system 100 illustrates only a single instance of each component. It will be appreciated that multiple instances of these components may be used. Moreover, the system 100 may include other devices not depicted in FIG. 1.

In various example embodiments, an account holder 106 may be any individual or entity that desires to conduct a financial transaction using one or more accounts held at one or more financial institutions. Also, an account holder may be a computer system associated with or operated by such an individual or entity. An account may include any place, location, object, entity, or other mechanism for holding money or performing transactions in any form, including, without limitation, electronic form. An account may be, for example, a credit card account, a prepaid card account, stored value card account, debit card account, check card account, payroll card account, gift card account, prepaid credit card account, charge card account, checking account, rewards account, line of credit account, credit account, mobile device account, or mobile commerce account. A financial institution may be, for example, a bank, other type of financial institution, including a credit card provider, for example, or any other entity that offers accounts to customers. An account may or may not have an associated card, such as, for example, a credit card for a credit account or a debit card for a debit account. The account card may be associated or affiliated with one or more social networking sites, such as a co-branded credit card.

In various example embodiments, a merchant 107 may be any retailer, wholesaler, point-of-sale (POS) location, or any other provider of goods or services. Merchant 107 may have one or more physical locations. Merchant 107 may be an online retailer. Merchant 107 may be any commercial or business entity where account holder 106 purchases goods or services using one or more financial accounts with financial institution 101.

Network 108 may enable communication between financial institution 101, auto chargeback system 102, one or more account holders 106, and one or more merchants 107. For example, Network 108 may be one or more of a wireless network, a wired network or any combination of wireless network and wired network. For example, network 108 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), Wireless Application Protocol (WAP), Multimedia Messaging Service (MMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g or any other wired or wireless network for transmitting and receiving a data signal.

In addition, network 108 may include, without limitation, telephone lines, fiber optics, IEEE Ethernet 902.3, a wide area network (“WAN”), a local area network (“LAN”), or a global network such as the Internet. Also network 108 may support an Internet network, a wireless communication network, a cellular network, or the like, or any combination thereof. Network 108 may further include one network, or any number of the example types of networks mentioned above, operating as a stand-alone network or in cooperation with each other. Network 108 may utilize one or more protocols of one or more network elements to which they are communicatively coupled. Network 108 may translate to or from other protocols to one or more protocols of network devices. Although network 108 is depicted as a single network, it should be appreciated that according to one or more embodiments, network 108 may comprise a plurality of interconnected networks, such as, for example, the Internet, a service provider's network, a cable television network, corporate networks, and home networks.

Referring to FIG. 1, Rules Processor 103 may be configured to receive one or more cases. In various examples, each case may comprise one or more transactions. The one or more transactions may have been previously indicated or flagged as, for example, fraudulent financial transactions. The one or more transactions may be transactions conducted using payment accounts (e.g., credit, debit, and/or stored value accounts) with one or more financial institutions, such as financial institution 101. The one or more transactions may have been performed at one or more merchants, such as merchant 107. The transactions may have previously been flagged as fraudulent by a financial institution, such as financial institution 101. Each of the one or more transactions in a case may have been flagged as fraudulent. The one or more cases may be stored in, for example, case database 105. Case database may be organized by one or more financial institutions. The one or more cases and one or more transactions may be stored in a format such as, for example, a flat file, an indexed file, a hierarchical database, a post-relational database, a relational database, such as a database created and maintained with software from, for example Oracle® Corporation, Microsoft® Excel file, Microsoft® Access file, or any other storage mechanism.

For each case, the one or more transactions in the case may be placed in a queue. Rules Processor 103 may be configured to retrieve each transaction from the queue and apply one or more filters to the transaction. Each transaction in the queue may have transaction data associated with it. Transaction data may be, for example, the transaction amount. The transaction data also may indicate the financial account that was charged for the transaction, such as a payment account with financial institution 101. The transaction amount may be the amount charged to the financial account at financial institution 101. Transaction data may include information identifying the merchant or POS location where the transaction was performed. Transaction data also may indicate whether the transaction was performed at an Automatic Teller Machine (ATM). Transaction data may indicate the geographic location where the transaction was performed, such as, for example, the street, city, state, county, zip code, country, region, time zone, or other relevant location information. Transaction data may indicate the date and time of the transaction. Transaction data may include whether the transaction included a signature. Transaction data may include the type of transaction, such as, for example, whether the transaction involved an online retailer or was performed at a point-of-sale location and, for example, whether a card was present during the transaction. The transaction data also may indicate whether the transaction was an e-commerce transaction. Transaction data may include the type of merchant, such as whether the merchant was a restaurant, an airline, a convenience store, clothing store, hardware, electronics, or other relevant types of merchants that offer goods and services in commerce.

Other data may be associated with each of the one or more transactions in a case. For example, if the transaction was flagged as fraudulent, the transaction may include fraud data. The fraud data may indicate whether the fraud was reported by an account holder. The fraud data may indicate whether the fraud was reported by a reporting agency. The fraud data may indicate whether the fraud was reported by a financial institution, such as financial institution 101, or if the fraud was reported by a third party. The fraud data may indicate whether a card associated with the financial account was lost or stolen.

Rules Processor 103 may create the queue of one or more transactions and apply one or more filters (or rules) to each transaction in the queue. Rules processor 103 may apply a first filter based on the transaction amount associated with each transaction. Rules processor may remove any transaction that is less than a predetermined amount. Rules processor may remove any transaction that is greater than a predetermined threshold amount. The predetermined threshold amount previously may have been inputted into the system. The predetermined threshold amount may vary depending on the type of transaction, or the category of transaction, or location of the transaction.

For example, rules processor 103 may filter out all transactions under $50 if the transaction was performed with an online retailer. Rules processor 103 may filter out all transactions under a threshold amount, such as, for example, $100 if the transaction was performed outside the United States. Other transaction amount rules may be applied. The rules may be preprogrammed into rules processor 103. The rules may be updated manually by one or more operators using, for example, a graphical user interface.

If a transaction is filtered out, rules processor 103 may “flag” the transaction as being ineligible for chargeback processing. Rules processor 103 may insert one or more codes into the transaction data indicating that the transaction is ineligible for chargeback processing. The inserted code may further indicate which rules/filters the flagged transaction failed to pass. The flagged transaction may be removed from the queue and transmitted back to case database 105, and/or a different database for flagged transactions. Once a transaction has been flagged as ineligible for chargeback processing, rules processor 103 may retrieve the next transaction in the queue and apply the one or more filters.

Rules processor 103 also may apply an additional filter to each transaction in the queue. The additional filter also may be based on whether the transaction was an ATM transaction. For example, the filter may flag any transaction that was performed at an ATM as ineligible for chargeback processing. The additional filter may be based on the location of the transaction. For example, the filter may flag any transaction that was performed in Canada as ineligible for chargeback processing. The additional filter may be based on the date and time of the transaction. For example, if the transaction is more than 180 days old, the rules processor 103 may flag the transaction as being ineligible for chargeback processing. The second filter may be a combination of multiple rules. For example, the rules may filter out any ATM transaction that is more than a threshold number of days, such as, for example, 90 days old. Other combinations may be used depending on the system needs.

As previously indicated, a transaction that is “filtered out” may be flagged as being ineligible for chargeback processing.

Rules processor 103 may run multiple filters based on the transaction data for each of the one or more transactions. If a transaction has passed through the one or more filters of rules processor 103, the transaction may be sent to chargeback processor 104. Chargeback processor 104 may be configured to determine whether the any additional documentation is required before the chargeback can be performed. Additional documentation may be required depending on the transaction data associated with the transaction. Additional documents may include one or more affidavits or fraud information forms detailing the transaction as fraudulent. Additional documentation may be required where the transaction was not manually imprinted. Additional documentation may be required where the transaction was not signed. The rules for when additional documentation is required may be provided or implemented by one or more third-parties.

If chargeback processor 104 determines that additional documentation is needed, chargeback processor 104 may identify, indicate or flag the transaction with a code indicating that more documentation is needed and may store the flagged transaction until the documentation is retrieved. Chargeback processor 104 may send a request for additional documentation to financial institution 101 associated with the transaction. Chargeback processor 104 also may send a request to merchant 107, or account holder 106, or a third-party entity (such as a credit reporting agency).

If chargeback processor 104 determines that additional documentation is not needed, chargeback processor 104 may initiate the auto chargeback process for the transaction. For example, the transaction may be sent to financial institution 101 with instructions to automatically perform the chargeback. The instructions may indicate whether the chargeback should be for the full amount of the transaction. The amount of the chargeback may depend on the transaction data for the transaction. For example, the chargeback processor may apply one or more chargeback rules to the transaction data to determine the amount of the chargeback. A chargeback rule may be setting a chargeback amount that is half the transaction amount for transactions over a threshold amount of such as, for example, $1,000. A chargeback rule may be setting a chargeback amount that is equal to the transaction amount for transactions that are less than 40 days old. The instructions also may be sent to a third-party entity that may perform the chargebacks. The instructions may include the transaction data for the transaction.

Chargeback processor 104 may send a notification to account holder 106 that a chargeback is being performed. The notification may be an electronic communication, such as an email, text message, SMS, Facebook message, Tweet, or other form of electronic communication.

Rules Processor 103 and chargeback processor 104 may be configured to perform the aforementioned steps for each of the one or more transactions in the queue.

FIG. 2 depicts an example system 200 that may enable a financial institution, for example, to provide network services to its customers. For example, system 200 may enable a financial institution to provide automated chargebacks operations. System 200 may comprise the components of, for example, a financial institution (e.g., financial institution 101), an account holder (e.g., account holder 106), a merchant (e.g., merchant 107), and/or an automated chargeback system (e.g., automated chargeback system 102). As shown in FIG. 2, system 200 may include a client device 202, a network 204, a front-end controlled domain 206, a back-end controlled domain 212, and a backend 218. Front-end controlled domain 206 may include one or more load balancers 208 and one or more web servers 210. Back-end controlled domain 212 may include one or more load balancers 214 and one or more application servers 216.

Client device 202 may be a network-enabled computer: As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 200 may execute one or more software applications to enable, for example, network communications.

Client device 202 also may be a mobile device: For example, a mobile device may include an iPhone, iPod, iPad from Apple® or any other mobile device running Apple's iOS operating system, any device running Google's Android® operating system, including for example, Google's wearable device, Google Glass, any device running Microsoft's Windows® Mobile operating system, and/or any other smartphone or like wearable mobile device.

Network 204 may be one or more of a wireless network, a wired network, or any combination of a wireless network and a wired network. For example, network 204 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 204 may include, without limitation, telephone lines, fiber optics, IEEE Ethernet 902.3, a wide area network (WAN), a local area network (LAN) or a global network such as the Internet. Also, network 204 may support an Internet network, a wireless communication network, a cellular network, or the like, or any combination thereof. Network 204 may further include one network, or any number of example types of networks mentioned above, operating as a stand-alone network or in cooperation with each other. Network 204 may utilize one or more protocols of one or more network elements to which they are communicatively couples. Network 204 may translate to or from other protocols to one or more protocols of network devices. Although network 204 is depicted as a single network, it should be appreciated that according to one or more embodiments, network 204 may comprise a plurality of interconnected networks, such as, for example, the Internet, a service provider's network, a cable television network, corporate networks, and home networks.

Front-end controlled domain 206 may be implemented to to provide security for backend 218. Load balancer(s) 208 may distribute workloads across multiple computing resources, such as, for example computers, a computer cluster, network links, central processing units or disk drives. In various embodiments, load balancer(s) 210 may distribute workloads across, for example, web server(S) 216 and/or backend 218 systems. Load balancing aims to optimize resource use, maximize throughput, minimize response time, and avoid overload of any one of the resources. Using multiple components with load balancing instead of a single component may increase reliability through redundancy. Load balancing is usually provided by dedicated software or hardware, such as a multilayer switch or a Domain Name System (DNS) server process.

Load balancer(s) 208 may include software that monitoring the port where external clients, such as, for example, client device 202, connect to access various services of a financial institution, for example. Load balancer(s) 208 may forward requests to one of the application servers 216 and/or backend 218 servers, which may then reply to load balancer 208. This may allow load balancer(s) 208 to reply to client device 202 without client device 202 ever knowing about the internal separation of functions. It also may prevent client devices from contacting backend servers directly, which may have security benefits by hiding the structure of the internal network and preventing attacks on backend 218 or unrelated services running on other ports, for example.

A variety of scheduling algorithms may be used by load balancer(s) 208 to determine which backend server to send a request to. Simple algorithms may include, for example, random choice or round robin. Load balancers 208 also may account for additional factors, such as a server's reported load, recent response times, up/down status (determined by a monitoring poll of some kind), number of active connections, geographic location, capabilities, or how much traffic it has recently been assigned.

Load balancers 208 may be implemented in hardware and/or software. Load balancer(s) 208 may implement numerous features, including, without limitation: asymmetric loading; Priority activation: SSL Offload and Acceleration; Distributed Denial of Service (DDoS) attack protection; HTTP compression; TCP offloading; TCP buffering; direct server return; health checking; HTTP caching; content filtering; HTTP security; priority queuing; rate shaping; content-aware switching; client authentication; programmatic traffic manipulation; firewall; intrusion prevention systems.

Web server(s) 210 may include hardware (e.g., one or more computers) and/or software (e.g., one or more applications) that deliver web content that can be accessed by, for example a client device (e.g., client device 202) through a network (e.g., network 204), such as the Internet. In various examples, web servers, may deliver web pages, relating to, for example, online banking applications and the like, to clients (e.g., client device 202). Web server(s) 210 may use, for example, a hypertext transfer protocol (HTTP or sHTTP) to communicate with client device 202. The web pages delivered to client device may include, for example, HTML documents, which may include images, style sheets and scripts in addition to text content.

A user agent, such as, for example, a web browser, web crawler, or native mobile application, may initiate communication by making a request for a specific resource using HTTP and web server 210 may respond with the content of that resource or an error message if unable to do so. The resource may be, for example a file on stored on backend 218. Web server(s) 210 also may enable or facilitate receiving content from client device 202 so client device AO2 may be able to, for example, submit web forms, including uploading of files.

Web server(s) also may support server-side scripting using, for example, Active Server Pages (ASP), PHP, or other scripting languages. Accordingly, the behavior of web server(s) 210 can be scripted in separate files, while the actual server software remains unchanged.

Load balancers 214 may be similar to load balancers 208 as described above.

Application server(s) 216 may include hardware and/or software that is dedicated to the efficient execution of procedures (e.g., programs, routines, scripts) for supporting its applied applications. Application server(s) 216 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Also, application server(s) 216 may act as a set of components accessible to, for example, a financial institution or other entity implementing system 200,through an API defined by the platform itself. For Web applications, these components may be performed in, for example, the same running environment as web server(s) 210, and application servers 216 may support the construction of dynamic pages. Application server(s) 216 also may implement services, such as, for example, clustering, fail-over, and load-balancing. In various embodiments, where application server(s) 216 are Java application servers, the web server(s) 216 may behaves like an extended virtual machine for running applications, transparently handling connections to databases associated with backend 218 on one side, and, connections to the Web client (e.g., client device 202) on the other.

Backend 218 may include hardware and/or software that enables the backend services of, for example, a financial institution or other entity that maintains a distributes system similar to system 200. For example, backend 218 may include, a system of record, online banking applications, a rewards platform, a payments platform, a lending platform, including the various services associated with, for example, auto and home lending platforms, a statement processing platform, one or more platforms that provide mobile services, one or more platforms that provide online services, a card provisioning platform, a general ledger system, and the like. Backend 218 may be associated with various databases, including account databases that maintain, for example, customer account information, product databases that maintain information about products and services available to customers, content databases that store content associated with, for example, a financial institution, and the like. Backend 218 also may be associated with one or more servers that enable the various services provided by system 200. Backend 218 also may be associated with an automated chargeback system. In various embodiments, backend 218 may include, for example, a rules processor, chargeback processor and a case database. Backend 218 also may interface with various third-party systems to provide the systems and methods described herein.

FIG. 3 provides an example method 300 for performing automated chargeback operations. The method 300 shown in FIG. 3 can be executed or otherwise performed by one or more combinations of various systems. The method 300 as described below may be carried out by the system for implementing automated chargeback operations as shown in FIGS. 1 and 2, by way of example, and various elements of that system are referenced in explaining the method of FIG. 3. Each block shown in FIG. 3 represents one or more processes, methods, or subroutines in the example method 300. Referring to FIG. 3, the example method 300 may begin at block 310.

At step 310, an auto chargeback system may receive a list of one or more transactions. The one or more transactions may be received via a network from a system associated with a case database (e.g., case database 105). The one or more received transactions may be received as one or more cases. The one or more transactions may be placed in a queue. The one or more transactions may be associated with one or more financial accounts. The one or more transactions may have been previously flagged as fraudulent. The one or more transactions may be transactions conducted using payment accounts associated with one or more financial institutions, such as financial institution 101. The one or more transactions may have been performed at one or more merchants, such as merchant 107. The transactions may have previously been flagged as fraudulent by a financial institution, such as financial institution 101. The one or more transactions also may have been flagged as fraudulent by a third-party.

Each transaction in a case may have transaction data associated with it. Transaction data may include the transaction amount. The transaction data may indicate the financial account that was charged for the transaction, such as a payment account (e.g., a credit, debit and/or stored value account) with financial institution 101. The transaction amount may be the amount charged to the financial account at financial institution 101. Transaction data may include information identifying the merchant or POS location where the transaction was performed and, for example, whether a card was present during the transaction. Transaction data also may indicate whether the transaction was performed at an Automatic Teller Machine (ATM). Transaction data may include information identifying the financial institution that provides the account to the account holder. Transaction data may include the name of the account holder. Transaction data may indicate the geographic location where the transaction was performed, such as, for example, the street, city, state, county, zip code, country, region, time zone, or other relevant location information. Transaction data may indicate the date and time of the transaction. Transaction data may include whether the transaction included a signature. Transaction data may include the type of transaction, such as, for example, whether the transaction involved an online retailer or was performed at a point-of-sale location. Transaction data may include the type of merchant, such as whether the merchant was a restaurant, an airline, a convenience store, clothing store, hardware, electronics, or other relevant types of merchants that offer goods and services in commerce. The transaction data may include one or more receipts associated with the transaction.

Other data may be associated with each of the one or more transactions in a case. For example, if the transaction was flagged as fraudulent, the transaction may include fraud data. The fraud data may indicate whether the fraud was reported by an account holder. The fraud data may indicate whether the fraud was reported by a reporting agency. The fraud data may indicate whether the fraud was reported by a financial institution, such as financial institution 101, or if the fraud was reported by a third party. The fraud data may indicate whether a card associated with the financial account (e.g., a credit, debit, or stored value account) was lost or stolen. Method 300 may proceed to block 330.

At block 330, method 300 may apply one or more filters to each transaction in the queue. The one or more filters may be based on one or more rules. For example, Rules Processor 103 may apply a rule based on the transaction amount for the transaction. At block 330, method 300 may determine if each of the one or more transactions complies with the one or more rules. If a transaction does not comply with one of the one or more rules, the transaction may be flagged as ineligible for chargeback processing in block 335. In various embodiments, a rule processor (e.g., rules processor 103) may insert a code in the transaction data indicating which rule or rules the flagged transaction failed to pass. If a transaction is flagged as ineligible, the transaction may be removed from the queue, and method 300 may proceed the next transaction in the queue at step 330.

The rules processor may apply one or more rules based the transaction amount. The rules processor may identify, indicate, or flag any transaction that is less than a threshold amount such as, for example, $300. Rules processor may apply one or more rules based on the location of the transaction. The rules processor may apply one or more rules based on the type of transaction, the date and time, the category, the fraud data, the financial institution information, and other data associated with the transaction. The one or more rules may be applied based on a combination of the aforementioned factors.

So for example, rules processor may filter out all transactions under $50 if the transaction was performed with an online or e-commerce retailer. The rules processor may filter out all transactions under a threshold amount of such as, for example, $100 if the transaction was performed outside the United States. The rules processor may filter out all transactions that are more than a threshold number of days, (such as, for example, 90 days) old if the transaction was performed at, for example, an ATM. The one or more rules may be preprogrammed into the rules processor. The rules may be updated manually by one or more operators using, for example, a graphical user interface.

If a transaction is filtered out, the rules processor may identify, indicate, or “flag” the transaction as being ineligible for chargeback processing. The rules processor may insert one or more codes into the transaction data indicating that the transaction is ineligible for chargeback processing. The flagged transaction may be removed from the queue and transmitted back to a case database (e.g., case database 105), or a different database for flagged transactions.

If a transaction accords with the one or more rules at step 330, method 300 may proceed to block 340 and the transaction may be flagged as eligible for chargeback processing. The rules processor 103 may insert a code into the transaction data for the transaction indicating that the transaction is eligible for chargeback processing. The code may be any type of alphanumeric code indicating that the transaction is eligible for chargeback processing. For example, the code may be a data field including a “Y” or a “1” or “YES” or the like that indicates eligibility.

At block 350, for each transaction that has been flagged as eligible, a chargeback processor (e.g., chargeback processor 104) may determine whether additional documentation is required. The chargeback processor may apply one or more rules to the transaction data for each eligible transaction to determine whether additional documentation is required. If the chargeback processor determines that additional documentation is required, the transaction may be flagged accordingly at step 355 and stored at one or more databases until the necessary additional documentation is retrieved. The chargeback processor may flag the transaction with a code indicating that more documentation is needed and may store the flagged transaction until the documentation is retrieved. The chargeback processor may send a request for additional documentation to a financial institution associated with the transaction. The chargeback processor may send a request to a merchant (e.g., merchant 107), or an account holder (e.g., account holder 106), or a third-party entity (such as, for example a credit reporting agency or the like).

If the chargeback processor determines that additional documentation is not needed, the chargeback processor may initiate the auto chargeback process for the transaction at step 360. The transaction may be sent to a financial institution with instructions to automatically perform the chargeback. The instructions may indicate whether the chargeback should be for the full amount of the transaction. The amount of the chargeback may depend on the transaction data for the transaction. For example, the chargeback processor may apply one or more chargeback rules to the transaction data to determine the amount of the chargeback. A chargeback rule may be setting a chargeback amount that is half the transaction amount for transactions over a threshold amount such as, for example, $1,000. A chargeback rule may be setting a chargeback amount that is equal to the transaction amount for transactions that are less than a threshold number (e.g., 40 days) old. The instructions may be sent to a third-party entity that performs the chargebacks. The instructions may include the transaction data for the transaction.

The Chargeback processor may send a notification to an account holder that a chargeback is being performed. The notification may be an electronic communication via a network, such as an email, text message, SMS, Facebook message, Twitter message (Tweet), or other form of electronic communication.

FIG. 4 provides an example method 400 for performing automated chargeback operations. The method 400 shown in FIG. 4 can be executed or otherwise performed by one or more combinations of various systems. The method 400 as described below may be carried out by the system for implementing automated chargeback operations as shown in FIGS. 1 and 2, by way of example, and various elements of that system are referenced in explaining the method of FIG. 4. Each block shown in FIG. 4 represents one or more processes, methods, or subroutines in the example method 400. Referring to FIG. 4, the example method 400 may begin at block 410.

At step 410, an automated chargeback system (e.g., automated chargeback system 102) may receive a list of one or more affidavits. The affidavit may identify one or more transactions as fraudulent. The affidavit may include one or more account identifiers associated with the fraudulent transactions. The affidavit may have been prepared by one or more fraud agents. The affidavit may have been prepared by a third-party. The affidavit may have been electronically prepared.

At step 430, method 400 may receive transaction data for each of the one or more transactions identified in the one or more affidavits. The transaction data may include an account identifier that identifies the financial account that was charged for the transaction, such as a payment account with financial institution 101. Transaction data may include the transaction amount. The transaction amount may be the amount charged to the financial account at financial institution 101. Transaction data may include information identifying the merchant or POS location where the transaction was performed. Transaction data may indicate whether the transaction was performed at an Automatic Teller Machine (ATM). Transaction data may include information identifying the financial institution that provides the account to the account holder. Transaction data may include the name of the account holder. Transaction data may indicate the geographic location where the transaction was performed, such as, for example, the street, city, state, county, zip code, country, region, time zone, or other relevant location information. Transaction data may indicate the date and time of the transaction. Transaction data may include whether the transaction included a signature. Transaction data may include the type of transaction, such as, for example, whether the transaction involved an online retailer or was performed at a point-of-sale location. Transaction data may include the type of merchant, such as whether the merchant was a restaurant, an airline, a convenience store, clothing store, hardware, electronics, or other relevant types of merchants that offer goods and services in commerce. The transaction data may include one or more receipts associated with the transaction.

Other data may be associated with each of the one or more transactions in a case. For example, if the transaction was flagged as fraudulent, the transaction may include fraud data. The fraud data may indicate whether the fraud was reported by an account holder. The fraud data may indicate whether the fraud was reported by a reporting agency. The fraud data may indicate whether the fraud was reported by a financial institution, such as financial institution 101, or if the fraud was reported by a third party. The fraud data may indicate whether a card associated with the financial account was lost or stolen.

At block 440, for each transaction received, method 400 may determine whether additional documentation is required. A chargeback processor may apply, for example, one or more rules to the transaction data for each eligible transaction to determine whether additional documentation is required. Additional documentation may be required where the transaction was not manually imprinted. Additional documentation may be required where the transaction was not signed. The rules for when additional documentation is required may be provided or implemented by one or more third-parties. If at step 440, method 400 determines that additional documentation is required, the transaction may be identified, indicated or flagged accordingly at step 440, and the appropriate additional documentation may be requested. The request may be sent to one or more financial institutions, or the merchant or POS location where the transaction occurred, or a third-party payment processor, or a credit reporting agency, other third party, or a combination of the above.

At block 450, method 400 may receive and review the requested additional documentation. If the additional documentation is adequate, method 400 may proceed to block 460 and perform the chargeback. If the documentation is not adequate, method 400 may repeat step 440.

At step 460, method 400 may perform the chargeback. The transaction may be sent to financial institution 101 with instructions to automatically perform the chargeback. The instructions may indicate whether the chargeback should be for the full amount of the transaction. The amount of the chargeback may depend on the transaction data for the transaction. For example, the chargeback processor may apply one or more chargeback rules to the transaction data to determine the amount of the chargeback. A chargeback rule may be setting a chargeback amount that is half the transaction amount for transactions over a threshold amount such as, for example, $1,000. A chargeback rule may be setting a chargeback amount that is equal to the transaction amount for transactions that are less than a threshold number of days (e.g., 40) days old. The instructions may be sent to a third-party entity that performs the chargebacks. The instructions may include the transaction data for the transaction.

The chargeback processor may send a notification to an account holder that a chargeback is being performed. The notification may be an electronic communication, such as an email, text message, SMS, Facebook message, Twitter message (Tweet), or other form of electronic communication.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, processors, etc.) separately. The functions described as being performed at various components may be performed at other components, and the various components may be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A system, comprising:
a data store that stores transaction data associated with one or more transactions, the one or more transactions being stored in a queue; and
an automated chargeback processor that retrieves transaction data associated with the one or more transactions stored in the queue, for each transaction in the queue, applies one or more rules to the transaction data, and identifies a transaction as eligible or ineligible for chargeback processing based on the one or more rules, wherein
for transactions that are identified as eligible, the processor determines whether additional documentation is required and sends instructions to perform a chargeback operation for an account associated with the transaction data.

2. The system of claim 1, wherein one of the one or more rules is associated with a transaction amount, and the transaction processor identifies the transaction as eligible if the transaction amount is greater than a predetermined threshold amount.

3. The system of claim 1, wherein the automated chargeback processor associates a code with the transaction data.

4. The system of claim 1, wherein, for transactions that are identified as ineligible, the chargeback processor takes no further action with respect to each respective transaction.

5. The system of claim 1, wherein one of the one or more rules is associated with whether a transaction was performed at an automated teller machine (ATM), and the transaction processor identifies the transaction as eligible if the transaction amount was performed at an ATM.

6. The system of claim 1, wherein one of the one or more rules is associated with a geographic area, and the transaction processor identifies the transaction as eligible if the transaction was performed within the geographic area.

7. The system of claim 1, wherein one of the one or more rules is associated with a period of time, and the transaction processor identifies the transaction as eligible if the transaction amount is performed with the period of time.

8. The system of claim 1, further comprising a communication module that receives additional documentation.

9. The system of claim 8, wherein the additional documentation includes an affidavit or fraud information form.

10. The system of claim 1, wherein one of the one or more rules is associated with a signature requirement, and the transaction processor identifies the transaction as eligible if the transaction has not satisfied a predetermined signature requirement.

11. A method, comprising:
storing, in a database, transaction data associated with one or more transactions in a queue
retrieving transaction data associated with one or more transactions stored in the queue;
for each transaction in the queue, applying, using an automated chargeback processor, one or more rules to the transaction data;
identifying, using the automated chargeback processor, the transaction data as eligible or ineligible for chargeback processing based on the one or more rules;
determining, using the automated chargeback processor, whether additional documentation is required; and
sending, via a network, instructions to perform a chargeback operation for an account associated with the transaction data.

12. The method of claim 1, wherein one of the one or more rules is associated with a transaction amount, and the transaction processor identifies the transaction as eligible if the transaction amount is greater than a predetermined threshold amount.

13. The method of claim 11, wherein the automated chargeback processor associates a code with the transaction data.

14. The method of claim 11, wherein, for transactions that are identified as ineligible, the chargeback processor takes no further action with respect to each respective transaction.

15. The method of claim 11, wherein one of the one or more rules is associated with whether a transaction was performed at an automated teller machine (ATM), and the transaction processor identifies the transaction if the transaction amount was performed at an ATM.

16. The method of claim 11, wherein one of the one or more rules is associated with a geographic area, and the transaction processor identifies the transaction as eligible if the transaction was performed within the geographic area.

17. The method of claim 11, wherein one of the one or more rules is associated with a period of time, and the transaction processor identifies the transaction as eligible if the transaction amount is performed with the period of time.

18. The method of claim 1, further comprising receiving the additional documentation via a network.

19. The method of claim 18, wherein the additional documentation includes an affidavit or fraud information form.

20. The method of claim 11, wherein one of the one or more rules is associated with a signature requirement, and the transaction processor identifies the transaction as eligible if the transaction has not satisfied a predetermined signature requirement.
